(19) United States
(12) Patent Application Publication
(10) Pub. No.: US 2016/0356082 A1
(43) Pub. Date: Dec. 8, 2016

(54) Venetian Blinds with Spring Loaded Lift and Guide Tapes

(71) Applicant: Timothy K. Gilmer, Gainesville, GA (US)

(72) Inventor: Timothy K. Gilmer, Gainesville, GA (US)

(21) Appl. No.: 14/729,413

(22) Filed: Jun. 3, 2015

(51) Int. Cl. E06B 9/322; E06B 9/66; E06B 9/386; E06B 9/303; E06B 9/325

(52) U.S. Cl. CPC E06B 9/322; E06B 9/303; E06B 9/325; E06B 9/386; E06B 9/66; E06B 2009/3222

(57) ABSTRACT

Venetian blinds include a pair of slat lift and guide tapes (27, 28) that extend from the upper stationary lift and guide rail (12), downwardly through openings (22) in the elongated parallel slats (14) and into the lower rail (13) where they are collected in the lower rail by coil tension springs (35). When the lower rail is raised, the lower portion of the lift and guide tapes are progressively pulled into the lower rail by the springs, and when the lower rail is properly located, a lock (38) engages the lift and guide tape to maintain the lower rail and some of the slats collected by the lower rail in a static condition.

### FIELD OF THE INVENTION

This invention concerns shades or “blinds” that include a plurality of parallel slats that can be tilted to open and allow light to be transmitted from one side to the other side of the blinds, or tilted to close and block the transmission of light from one side to the other side of the blinds. Typically these blinds are referred to as Venetian blinds and are used at windows and doors to control the passage of light there through.

### BACKGROUND OF THE INVENTION

The prior art Venetian blinds include a series of parallel slats that can be tilted to either open or close visual passage of light from one side to the other side of the blinds. Venetian blinds typically include an upper stationary support rail for mounting to the upper frame of a window and a lower movable support rail, with the slats suspended between the support rails, and pull cords that extend upwardly from the reach of the person operating the blinds to the upper rail then downwardly from the upper rail through openings in the parallel slats to the lower rail. When the person pulls the cords, the bottom rail moves upwardly and progressively collects the slats to lift them higher to raise the blinds.

While Venetian blinds have been known in the prior art for many decades, most of them have included the lifting cords described above, which is a concern in the industry because there have been several deaths or near deaths of children that have inadvertently become entangled in the lift cords and have been choked. Further, when the lift cords are pulled downwardly, a significant force is applied by the pull cords to the supporting upper rail and its components, which tends to pull the upper rail away from the supportive wall structure. This requires that the upper rail be very securely constructed and securely attached to the window frame and allows the person operating the Venetian blinds to apply significant downward force to lift the lower slats toward the top of the window frame.

Also, once the pull cord has been pulled to lift the lower rail and its adjacent slats, the operator must manipulate the pull cord while the pull cord holds the slats at the desired position and to engage a catch in the upper rail that prevents the pull cord from allowing the slats and lower rail to move uncontrollably down. But the higher the blinds are raised the more the pull cord is moved downwardly within the reach of children, increasing the hazard of access and injury to children.

Even with the blinds in this fully lowered position with the pull cords out of reach of children, the portion of the pull cords that extend through the slats can still be reached by children. This is known as an accessible inner cord.

“Cordless” Venetian blinds have been developed that have no outer cord but they do include inner cords that extend from the upper rail to the bottom rail so the inner cords are still available to children and pose a risk to child strangulation.

Other means have been developed that have attempted to solve the above described problems, but there still remains a need to have affordable cordless Venetian blinds to avoid the hazards, inconvenience and non-durability of the structure that comprises the blinds, and the need to provide cordless blinds and to reduce the amount of force that is required to raise the blinds.

Accordingly, it is an object of this invention to provide improved Venetian blinds that can be manually lifted for raising the blinds and manually moved downwardly to lower the blinds without the use of a pull cord or an inner cord, and with the effort for lifting and lowering the blinds being less than the weight of the blinds as they are accumulated or released.

And it is another object of this invention to provide Venetian blinds that include substantially rigid lift and guide tapes that act as a track to guide the slats and to collect the slats as the slats are lifted and lowered.

Further, there is a need for providing a reliable and easily applied “brake” in Venetian blinds that positively maintains the lower rail at a desired height.

Other objects, features and advantages of the present invention will become apparent upon reading the following specification, when taken in conjunction with the accompanying drawings.

### BRIEF DESCRIPTION OF THE DRAWINGS

FIG. 1 is a perspective view of a set of Venetian blinds with some portions of the blinds removed for the purpose of showing the various components of the blinds.

FIG. 2 is a side view of the upper portion of the Venetian blinds shown along lines 2-2 of FIG. 1.

FIG. 3 is a perspective view of the end portion of a single slat and one of its two “ladder cords” that supports the slats at equally spaced vertical distances from one another, and one of the two lift and guide tapes extending through the aligned openings of the slats.

FIG. 4 is a side cross sectional view of one of two tape collectors that are mounted in the lower rail of the Venetian blinds.

### DETAILED DESCRIPTION

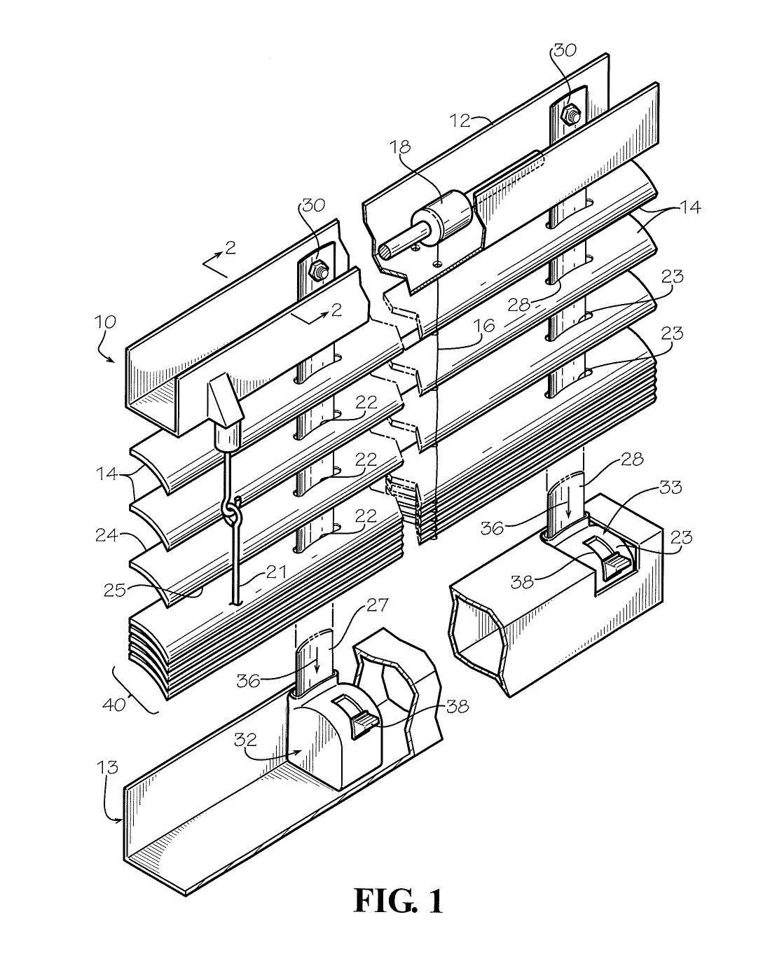

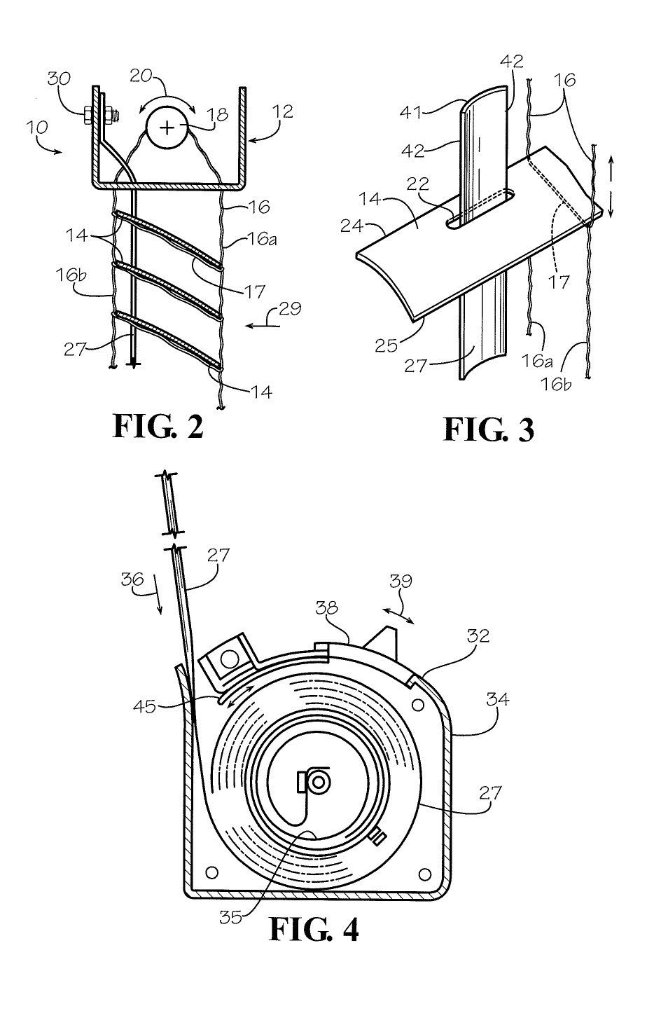

Referring now in more detail to the drawings, in which like numerals indicate like parts throughout the several views, FIG. 1 shows assembled Venetian blinds with parts that are removed for clarity. The Venetian blinds 10 include an upper stationary support rail 12, a lower movable support rail 13, and a plurality of elongated and equally spaced slats 14 extending parallel to one another and positioned between the lower rail 13 and upper rail 12. A pair of conventional ladder strings 16 extends downwardly from the upper rail 12. As best shown in FIGS. 2 and 3, the ladder strings 16 each include a pair of vertical support lines 16a and 16b that are positioned on opposite sides of the slats 14 and a series of laterally extending parallel slat support legs 17 extend between the pair of vertical support legs. The ladder strings support the slats in the conventional manner.

The vertical support lines 16a and 16b of the ladder strings 16 extend upwardly into the upper stationary support rail about a rotatable drum 18 and the drum can be rotated as indicated by arrows 20 in FIG. 2. The ladder strings 16 extend over the rotatable drum and the drum may be rotated in the conventional manner by a person rotating the control rod 21.

When a person rotates the control rod 21, the drum 18 also rotates and the ladder strings 16a and 16b move up on one side and down on the other side. The support legs 17 of the ladder strings that extend under each slat maintain the elongated parallel slats 14 oriented parallel to each other, thereby reorienting the angles of the elongated parallel slats 14. This is conventional in the art.

As best shown in FIGS. 1 and 3, each of the slats 14 defines a pair of lift and guide tape openings 22 and 23 that are oblong in shape, with a long axis parallel to the length of the elongated parallel slats and with the lift and guide tape openings 22 and 23 being positioned closer to the outer edge 24 of the slats 14 than the inner edge 25. The outer edge 24 of slats faces the window opening and the inner edge 25 faces away from the window opening (not shown). When the elongated parallel slats are tilted, the inner edge 25 of the slats tends to block the view of the lift and guide tape opening 22, as shown by arrow 29 in FIG. 2.

Lift and guide tapes 27 and 28 extend from the lower movable support rail 13 up through the support tape openings 22 in the slats 14, up to the upper rail 12 and into the upper rail and are attached to the upper rail by screws or other conventional connector means 30.

The tape collectors 32 and 33 are mounted in the lower rail 13 as shown in FIG. 1 and the lift and guide tapes 27 and 28 extend upwardly from the tape collectors.

As shown in FIG. 1, the tape collectors 32 and 33 may be identical and as shown in FIG. 4 each includes a spring actuated retractable tape assembly. The tape collectors include a housing 34, a coil spring 35, and the lift and guide tape 27 is wound about the coil spring 35. The tape collectors 32 and 33 may comprise a conventional design so that the lift and guide tapes 27 and 28 are spring urged to move in the direction of arrow 36 into the confines of the housing 34.

As shown in FIGS. 1 and 4, the tape collectors 32, 33 each include a tape lock 38 that is slidably mounted in the upper portion of the tape housing 34 and may be moved as indicated by the double arrow 39 (FIG. 4) in either direction. When moved to the left in FIG. 4 toward the tape 27, the tape lock engages the lift and guide tape 27 and presses it against the housing 34, to lock the tape against the tape housing 34. When the tape lock is moved away from the housing, the coil spring 35 urges the lift and guide tape into the housing 34. When both of the tape locks 38 on the pair of tape collectors 32, 33 engage their respective tapes, the vertical movement of the lower rail 13 is maintained in a static situation where it will not move vertically with respect to the parallel slats 14.

When the tape locks 38 are moved away from engagement with the tape 27, the tape 27 is free to move into or out of the housing 34 of the tape collector and the coil spring urges the tape to enter the housing 34.

### Operation

The Venetian blinds 10 will be mounted at a window with the upper stationary support rail 12 supported by a bracket or other suitable supportive structure at the desired height, installed in static relationship with respect to the supportive structure. The elongated parallel slats 14 are suspended by the pair of ladder strings 16 beneath the upper stationary support rail as shown in FIGS. 1 and 2, with the slats being uniformly spaced apart in parallel orientation. This is conventional.

When the assembly is being mounted to the window, the tape locks 38 of the tape collectors 32, 33 typically will be in engagement with the lift and guide tapes 27 and 28 so that the lower rail 13 is maintained up away from the usual lowered position. However, once the upper rail 12 is properly mounted at a window, the tape locks 38 may be opened by moving them away from engagement with the lift and guide tapes 27 and 28.

When the tape locks are opened, the lower rail 13 may be raised or lowered by a person using his or her hands to lift or lower the lower rail. In the meantime, the coil springs 35 are movable with respect to the lower rail and tend to retract the lift and guide tapes 27 and 28 into the lower rail. The pull by the springs in each tape collector 32, 33 against the lift and guide tapes tends to relieve the amount of weight that the person has to lift when raising or lowering and/or otherwise adjusting the height of the lower rail 13.

More specifically, the tape collectors 32, 33 operate independently of one another so that the person lifting or lowering the lower rail 13 by hand can tilt the lower rail to make sure that the lower rail is at the desired attitude. Further, the force applied by the coil springs 35 to the lift and guide tapes 27, 28 tends to pull the lift and guide tapes into the housing, as indicated at 36 in FIG. 4. This tends to draw the lower rail upwardly, but usually with not enough force to actually lift the lower rail. Preferably, the bias of the spring 35 may be powerful enough to lift and guide the weight of the lower rail and the weight of some of the lower slats 14 that have been collected as indicated at 40 in FIG. 1. Also, the springs 35 may be chosen to have enough strength to exert enough lifting forces to lift both the bottom rail and all of the slats to the upper rail.

When the lower rail is lifted by hand and the tape collectors 32 are unlocked, the lift and guide tapes 27 and 28 are drawn into the tape collectors 32, 33 by their springs 35 and the lower ones of the slats 14 adjacent the lower rail 13 tend to stack and accumulate on top of the lower rail. The tape collectors 32, 33 are configured for collecting or releasing the lower portions of the slat lift and guide tapes in response to raising and lowering the lower rail, respectively. The tape collectors tend to form the tapes 27 in a coil that wraps around the coil spring 35 in the tape collector. The upper ends of the retractable lift and guide tapes are immovably fastened to the upper rail 12. Once the lower rail is at the desired height and is level, the person handling the blinds will move the tape locks 38 as illustrated at 39 of FIG. 4 to move their ends 45 to engage the tape 27 and to lock the tape against the housing 34.

As shown in FIG. 3, the lift and guide tapes 27 and 28 may be curved in cross section. But when the lift and guide tapes are retracted into the housing 34 by the coiled spring 35, the tapes tend to flatten in cross section.

The curved cross sections 41 of the extended portions of the lift and guide tapes 27 and 28 tend to provide rigidity to the tapes and maintain the tapes in their straight configuration. The curved shape of the cross section of the tapes 27 and 28 that pass through the oblong shaped support tape openings 22 of the slats 14 tends to cause the opposed edges of the lift and guide tapes to engage the facing edge of the support tape openings 22 of the slats and the central portion of the curved shape of the support tapes tends to engage the opposite side of the edge of the support tape openings 22. This tends to provide lateral support to the slats so that the slats tend to retain their aligned relationship.

Since the lift and guide tapes are mounted in the lower rail 13, the tape collectors 32 and their locks 38 usually are positioned at a height that is convenient to the person that is raising or lowering the lower rail and the adjacent slats 14.

Although preferred embodiments of the invention have been disclosed in detail herein, it will be obvious to those skilled in the art that variations and modifications of the disclosed embodiments can be made without departing from the spirit and scope of the invention as set forth in the following claims.

1. Venetian blinds assembly for hanging at a window opening, comprising:
an upper rail for mounting above a window opening,
a lower rail positioned below the upper rail,
a plurality of elongated parallel slats positioned between the upper rail and the lower rail and extending parallel to the upper rail, the parallel slats each including a pair of slat openings extending there through, with the pairs of slat openings of adjacent slats positioned in alignment with one another,
a pair of slat lift and guide tapes each including a distal end and a proximal end portion, the distal end portion of both slat lift and guide tapes attached to the upper rail and the slat lift and guide tapes are suspended downwardly from the upper rail through the slat openings of the parallel slats to the lower rail,
a pair of tape collectors mounted to the lower rail, each tape collector of the pair of tape collectors supported by the lower rail in vertical alignment with the slat openings of the slats and in vertical alignment with the slat lift and guide tapes, each tape collector configured for collecting and releasing the lower portion of one of the slat lift and guide tapes in response to raising and lowering the lower rail respectively.

2. The Venetian blinds of claim 1, wherein the pair of slat lift and guide tapes are configured to form a coil when retracted into the tape collectors.

3. The Venetian blinds of claim 1, wherein the tape collectors each include a spring connected to the slat lift and guide tape for gathering the slat lift and guide tape into the lower rail.

4. The Venetian blinds of claim 3, wherein the spring comprises a coil spring.

5. The Venetian blinds of claim 2, wherein the pair of slat openings in the slats are oblong with a long axis parallel to the length of the elongated parallel slats, and the lift and guide tapes have a width extending parallel to the long axis of the slat openings.

6. The Venetian blinds of claim 1, wherein each slat includes an outer edge for facing the window opening and an inner edge for facing away from the window opening,
the slat openings are positioned closer to the outer edge than to the inner edge, and the slat lift and guide tapes extend closer to the outer edge than the inner edge.

7. The Venetian blinds of claim 1, wherein the slat lift and guide tapes are concave in cross section.

8. A Venetian blinds assembly for mounting to a window frame comprising:
an upper rail for mounting to the window frame above the window opening and a lower rail positioned below the upper rail,
a series of slats positioned between the upper rail and the lower rail, the slats each defining a pair of openings aligned with the pair of openings of adjacent ones of the slats,
a pair of retractable lift and guide tapes each fastened at one end to the upper rail and extending downwardly from the upper rail through the aligned openings of the slats to the lower rail,
a pair of coil springs mounted in the lower rail, each coil spring connected to one of the lift and guide tapes and biased to retract a lift and guide tape toward the lower rail in response to manually lifting the lower rail toward the upper rail.

9. The Venetian blinds assembly of claim 8, wherein the pair of retractable lift and guide tapes are immovably fastened to the upper rail.

10. The Venetian blinds of claim 8, wherein the coil springs are mounted in the lower rail and in vertical alignment with the openings of the slats.

11. The Venetian blinds of claim 10, and further including a brake for each coil spring to lock or release the movement of the lift and guide tape with respect to the lower rail.

12. The Venetian blinds of claim 8, and wherein the slats are the same shape and dimension and include front and rear edges, and the aligned openings are positioned closer to the rear edges adjacent the rear edges of the slats so that when the slats are tilted the front edges of the slats visually obscure the aligned openings of the slats and the lift and guide tape.

13. The Venetian blinds of claim 8, and wherein a pair of ladder tapes each are supported at one end to the upper rail and are suspended downwardly toward the lower rail for supporting the slats not supported by the lower rail.

14. The Venetian blinds of claim 8, wherein the retractable lift and guide tapes are concave in cross section for bearing against the pair of openings in the slats.

15. Venetian blinds for hanging at a window opening, comprising:
an upper rail,
a lower rail positioned below the upper rail,
a plurality of parallel slats extending horizontally between the upper rail and the lower rail,
a pair of lift and guide tapes extending vertically from the upper rail into the lower rail at a position where the lift and guide tapes support the lower rail,
a spring mounted in the lower rail at each position where the lift and guide tapes support the lower rail, each spring configured for urging one of the pair of lift and guide tapes into the lower rail.

16. The Venetian blinds of claim 15, wherein the springs are tension springs that are biased to urge the lift and guide tapes into the lower rail.

17. The Venetian blinds of claim 16, wherein the tension springs are coil springs, and further including a brake at each coil tension spring for locking the tapes to the lower rail.
